(19) United States
(12) Patent Application Publication
(10) Pub. No.: US 2026/0259653 A1
(43) Pub. Date: Sep. 3, 2026

(54) LARGE LANGUAGE MODEL FOR PROVIDING USER ASSISTANCE TO USER OF MICROSCOPE

(71) Applicant: Carl Zeiss Microscopy GmbH, Jena (DE)

(72) Inventors: Christof KRUG, Munich (DE); Christoph KUEBLER, Munich (DE); Martin KUTTGE, Munich (DE); Uros KRZIC, Gauting (DE); Roger LANDOLT, Munich (DE); Eva SIMBUERGER, Schwielowsee (DE); Sebastian SOYER, Munich (DE); Iosif SERAFEIMIDIS, Rostock (DE); Simon FRANCHINI, Munich (DE)

(73) Assignee: Carl Zeiss Microscopy GmbH, Jena (DE)

(21) Appl. No.: 19/552,560

(22) Filed: Feb. 27, 2026

(30) Foreign Application Priority Data
Feb. 28, 2025 (DE) 102025107694.4

(51) Int. Cl. G06F 3/04847; G06F 3/0481; G06F 9/451

(52) U.S. Cl. CPC G06F 3/04847; G06F 3/0481; G06F 9/453

(57) ABSTRACT

The disclosure generally pertains to techniques of providing user assistance when using a microscope to investigate a sample. According to the disclosed techniques, a trained large language model is used to generate the user assistance information. The disclosed techniques enable provisioning of user assistance information that is tailored to the graphical user interface that is used by a user to interact with the microscope.

### FIELD OF THE INVENTION

Various examples of the disclosure pertain to providing a user of a microscope with user assistance when using the microscope to acquire images of a sample.

### BACKGROUND OF THE INVENTION

Microscopes are used in a wide variety of applications, such as imaging semiconductor samples, imaging biological samples such as cells or tissues, examining composite materials, in-line testing of a production line, end-of-line testing of a production line, academia and manufacturing, etc.

There are also a wide variety of microscope types, including but not limited to light microscopes, particle microscopes and atomic force microscopes. Even within such a particular type of microscope, there are a variety of subtypes. For example, there are many different types of light microscopes, e.g. using different imaging modalities, different illumination configurations, using different filters in the detection path, etc. Phase or amplitude imaging is possible. Fluorescence imaging or light sheet imaging are other possibilities. Sometimes a single microscope can be controlled to provide many different such imaging modalities, e.g. by activating or deactivating the use of certain optical filters in the imaging path, by using a certain illumination configuration and/or by using certain post-processing of the images.

This variability between use cases, coupled with the complexity of the hardware/software, makes it difficult to provide tailored user support to microscope users. For example, a microscope manufacturer may be faced with the task of providing overly comprehensive user manuals that cover all the different types of use cases and microscope hardware/software configurations. On the other hand, such complex manuals make it difficult for the user to find the specific information he or she is interested in.

### SUMMARY OF THE INVENTION

Accordingly, there is a need for advanced techniques of providing user assistance when using a microscope to investigate a sample. Specifically, there is a need for techniques that provide user assistance in a relatively tailored manner, enabling a user to retrieve the particular information useful to the task at hand within short time.

This need is met by the features of the independent claims. The features of the dependent claims define embodiments.

Techniques are disclosed for statically or dynamically generating context data for a current setting of a microscope and organizing it into a standardized machine-comprehensible format. The context data can then be utilized by a large language model (LLM) – e.g., a chat assistant – to provide accurate user guidance to a user of the microscope, e.g., providing guidance which interface elements of a graphical user interface (GUI) to use or set in a certain manner in order to achieve a desired result.

A computing device-implemented method for providing user assistance is disclosed. The user assistance is provided when using a microscope to investigate a sample. The method includes providing a GUI to the user. The GUI is suitable for depicting a microscopic image of the sample that is acquired using the microscope. The GUI is alternatively or additionally suitable for setting a configuration of an imaging process that is associated with the microscopic image. The method also includes generating context data for the microscope based on the current setting of the microscope. The method further includes triggering inference of a trained LLM based on the context data, to thereby generate user assistance information. The method also includes providing the user assistance information to the user.

A GUI may refer to a visual interface that allows users to interact with the microscope through graphical elements such as icons, menus, and windows. The GUI may display microscopic images acquired by the microscope and provide interface elements as controls for adjusting imaging parameters or configurations. For example, the GUI can include tools for setting exposure times, selecting filters, or activating specific imaging modalities. Alternatively or additionally to such hardware settings, the interface elements may enable to set one or more software postprocessing steps applied to acquired images.

A microscope may be a light microscope or a particle microscope. A microscope may be a scanning electron microscope. Transmission or reflection microscopy may be used. The techniques disclosed herein can be applied to various kinds and types of devices that provide microscopic images.

A microscopic image may be a visual representation of a sample captured using a microscope. Such microscopic images can be generated through various imaging techniques such as brightfield microscopy, fluorescence microscopy, phase-contrast microscopy, or other modalities depending on the type of microscope and its configuration. The microscopic image may be displayed in real-time during the acquisition process or stored for later analysis.

The context data may refer to information that describes the current state of the microscope and the imaging environment. This data can include settings such as magnification level, illumination intensity, filter configurations, imaging modality selections, and other parameters relevant to the operation of the microscope. The context data is used to infer user needs or provide tailored assistance during the imaging process.

The LLM may include a sequence-to-sequence deep neural network employing a transformer architecture. The transformer architecture may include one or more multi-headed self-attention layers. These layers allow to jointly attend to information from different representation subspaces at different positions, thereby capturing complex contextual relationships in the context data. The LLM may have been trained using unsupervised training methods, such as masked language modeling or next sentence prediction. This allows the LLM to learn general language patterns and relationships that are not specific to a particular domain or task. As a result, the LLM can be considered domain-agnostic, meaning it is not limited to a specific application or use case. In some examples, the LLM may have been trained using a large corpus of text data, such as books, articles, and websites. This training data may not have been be limited to information related to microscopes or microscopy, but rather general language patterns and relationships that can be applied to a wide range of tasks. The LLM may have a large number of parameters, e.g., tens of millions or even hundreds of millions of parameters. These parameters are learned during the training process and allow the LLM to capture complex patterns and relationships in the context data.

By triggering the inference of the LLM to generate the user assistance information taking into account the context data, the user assistance information can be provided in a state-aware manner tailored to the particular situation faced by the user when interacting with the user interface. Thus, more tailored user assistance information can be provided.

According to examples, the context data may be indicative of a current hardware setting of the microscope. The current hardware setting of the microscope may include information on, e.g., the used illumination, the active or deactivated filters, illumination wavelength, objective lens, magnification, etc.

A hardware setting of a microscope may refer to a configuration or adjustment made to the physical components of the microscope, which can affect the imaging process and the resulting microscopic image. Such settings may include, but are not limited to, adjustments to the objective lens, illumination sources, filters, polarizers, and other optical elements. The hardware setting of a microscope can impact various aspects of the imaging process, such as resolution, contrast, brightness, and color accuracy. For example, adjusting the focus of the objective lens or changing the magnification power may be considered a change in the hardware setting. Similarly, switching between different illumination sources, such as brightfield, darkfield, or fluorescence, can also be viewed as a modification to the hardware setting. The specific settings used for imaging may depend on various factors, including the type of sample being observed, the desired level of resolution, and the intended application.

The context data may be indicative of a current image acquisition setting of the microscope. The image acquisition setting may include, e.g., parameters of the camera sensor such as exposure time, frame rate, sensitivity, etc.

As will be appreciated from the above, the current hardware setting and/or current image acquisition setting pertains to the current state of the microscope and describes properties impacting the appearance of the acquired microscopic images. For instance, depending on the hardware setting and/or image acquisition setting, different structures may appear with different contrast in the resulting microscopic images. For instance, the current hardware setting and/or the current image acquisition setting may impact the active imaging mode, e.g.: brightfield imaging, dark-field imaging, phase-contrast imaging, fluorescence imaging, etc. to give just a few examples.

Alternatively or additionally to such information included in the context data that immediately impacts the appearance of the microscopic image, the context data may also include other or further information that less directly impacts the appearance of the microscopic image.

For instance, the context data may include a log file of the microscope. For instance, such log file may include state monitoring information detected by one or more control units of the microscope and/or one or more sensors of the microscope.

A log file of a microscope may refer to a record or archive of data that documents various events, activities, or changes related to the operation and performance of the microscope over time. Such logs may include information about instrument settings, user interactions, image acquisition parameters, system errors or warnings, maintenance records, and other relevant details. In the context of providing user assistance, log files can serve as a resource for understanding historical patterns and trends in microscope usage and performance. By analyzing data from the log file, the LLM may gain insights into how the microscope has been used in the past, including common settings, frequent errors or issues, and other relevant information that can inform its user assistance recommendations. The log file may be stored locally on the microscope itself, or it may be transmitted to a remote server for centralized storage and analysis. In some cases, multiple microscopes may contribute data to a single, shared log file, enabling broader insights into patterns and trends across different instruments and users. Log files can also include information about software updates, firmware revisions, and other changes made to the microscope's operating system or application programs over time. This information can help the LLM understand how changes to the microscope's configuration may impact its performance and behavior, enabling more accurate and informed user assistance recommendations.

The context data may include an error message that is output via system software of the microscope. Such error message may pertain to hardware errors such as mechanical errors or electrical errors of one or more components of the microscope. The error message may alternatively or additionally pertain to software errors, e.g., lack of access rights, failed control tasks, etc.

The context data may include a sensor reading of a sensor of the microscope. For instance, temperature sensor or a humidity sensor of the microscope may provide repeated sensor readings in a certain sampling rate and the log file may include such information.

The provisioning of such information that pertains to the overall operation of the microscope and is not strictly tied to the imaging process may enable to reveal underlying issues or problems that manifest in the appearance of the microscope image. For instance, a degraded imaging quality may have a root cause in a certain hardware or software defect of the microscope. To perform such root cause analysis, it is helpful to obtain additional context data going beyond the optical path and image processing, characterizing the general state of operation of the microscope. For example, if a user is experiencing difficulties with image quality, the LLM may analyze various pieces of information, including sensor readings, error messages, and log file data, to determine that the root cause of the problem is a malfunctioning temperature control system. This understanding can then inform the LLM's recommendations for troubleshooting and resolving the issue. In some cases, identifying the root cause of an issue may thus include analyzing data from multiple sources and using techniques such as correlation analysis or causal inference.

The context data may be indicative of a current software configuration of one or more image processing software modules of the microscope.

For example, the microscope may include one or more cameras that require one or more raw images. These one or more raw images may be then post-processed using the one or more image processing software modules of the microscope. For instance, multiple raw images may be acquired using different illumination settings such as different illumination directions. The raw images may then be combined using digital postprocessing in an image processing software module to obtain the microscopic image. The microscopic image thus obtained may have a digital phase contrast. The image postprocessing techniques are conceivable such as denoising, anti-aliasing, etc. to give just a few examples. Certain digital filters may be applied.

By providing such information on the image postprocessing that is currently being used to the LLM, the LLM may provide tailored user assistance, also with respect to one or more settings of such image processing software module.

The context data may be indicative of a current setting of the GUI. The GUI may be user adaptable. For instance, certain interface elements may be rearranged or may be altogether activated or deactivated. For instance, a toolbar of interface elements may be hidden or expanded. The context data could be indicative of which interface elements are visible or which interface elements are hidden or where a certain visible interface element is placed/positioned. The context data may be indicative of an arrangement of the different interface elements on a screen. This enables the LLM to provide simplified user guidance, e.g., indicating to the user where a particular interface element that should be clicked or modified by the user’s position on the screen. In particular for scenarios in which the GUI includes a large number of interface elements that are, in addition, configurable as to their appearance and/or visibility, such techniques can greatly increase practicability of the user assistance provided to the user.

The context data may be indicative of a user interaction with the GUI. For example, the context data may include a list of interface elements with which the user has recently interacted. A sequence of interface elements may be indicated. An “action history” listing certain actions taken by the user may be included in the context data. This enables the LLM to understand what actions the user has previously tried in connection with the control of the microscope. For instance, this may enable the LLM to tidy further user assistance information and instructions to such previously tried actions taken by the user, thereby providing user-specific user assistance tailored to the previous activity of that particular user.

More generally, the context data may provide information associated with the particular user that triggers the request for user assistance. This information may not pertain to, e.g., a particular query input by the user and identifying the user assistance asked for by the user; rather this user-related information may pertain to general properties of the user beyond the specific query. The context data may be user specific. The context data may be indicative of information associated with a user of the GUI. Such techniques enable to provide user-specific user assistance, e.g., tailored to the particular skill level of that user and/or tailored to the user access rights of that particular user.

The context data may be indicative of user-related information including a unique user identifier. Such unique user identifier may be associated with a user repository of users allowed to use the GUI. Thus, the user identifier may be a local user identifier associated with a particular microscope or set of microscopes in a local environment. Alternatively or additionally, it may also be possible to use a global user identifier, e.g., associated with a global user repository of users registered at a manufacturer of the GUI and/or microscope. Typically, such global user repository may be stored at an online server, thereby accessible to multiple different instances of the GUI deployed at different sites.

The context data may be indicative of a user skill level. The user skill level may, e.g., indicate a time duration of the user having interacted with the GUI. The user skill level may be a classification indicator ranking the user experience into a set of predefined user skill level classes. The user skill level may be indicative of certain operations are tasks that the user has previously executed or has not yet previously executed via the GUI; this may be tracked by a background monitoring process of the GUI. Such information on the user skill level may be linked to the unique user identifier discussed above. By providing the user's skill level, the complexity of the user assistance can be tailored to the user's skill level. For example, certain relatively complex user guidance information may not be provided to a relatively inexperienced user. Similarly, certain interaction patterns or instructions may not be provided to certain users. Alternatively or in addition to tailoring the complexity of the user assistance itself, it is also conceivable to tailor the presentation of the user assistance to the user's skill level. For example, while for a particularly experienced user a relatively granular and high-level set of instructions for using the GUI and/or manipulating the microscope may be sufficient to enable that experienced user to carry out the instructions, for a less experienced user a more detailed step-by-step set of instructions may be necessary to enable that user to follow the instructions. In this way, the amount of information per user assistance or the granularity of the user assistance can be adjusted according to the user's skill level.

The context data may be indicative of an abnormal user interaction pattern with the GUI. An abnormal user interaction pattern may pertain to a user interaction pattern that represents an outlier if compared to a certain reference collection of user interaction patterns. An abnormal user interaction pattern may pertain to the user interaction pattern that has not yet been previously seen in a certain reference collection of user interaction patterns. Such reference collection of user interaction patterns may be user-specific for the particular user; in other words, the abnormal user interaction pattern may be abnormal within the scope of that particular user. Such reference collection of user interaction patterns may also be globally valid for a set of users so that the abnormal user interaction pattern may be abnormal not only for the particular user but rather for a plurality of other users. There are different techniques of detecting such abnormal user interaction patterns. For instance, the actual user interaction pattern may be compared against a reference catalog of user interaction patterns. A heuristic distance metric may be employed. If the actual user interaction pattern is not found in that reference catalog of user interaction patterns, the actual user interaction pattern may be flagged as abnormal. A machine-learned abnormality detector can be used, e.g., an autoencoder. Here, a sequence of coded user interactions is fed to the encoder of the autoencoder. The encoder then determines a latent representation at the bottleneck and subsequently attempts to reconstruct the feature vector using a decoder. The autoencoder has been trained using a training data set that includes a reference collection of user interaction patterns. For an abnormal user interaction pattern the reconstructed feature vector will show a significant deviation from the feature vector so that the associated user interaction pattern can be detected as abnormal. Such techniques are based on the finding that an abnormal user interaction pattern can correlate with certain problematic or defective system settings of the microscope. The user may have activated or deactivated certain settings that are normally deactivated or active. The user may have performed activities that have not been intended and are outside of the scope of typical user manuals.

The context data may be indicative of a user permission level. The user permission level may regulate which settings of the microscope and/or the postprocessing or more generally which settings of the GUI a certain user may alter. In particular for relatively complex microscopes which bear a risk of being damaged, the user permission level can be restricted for certain inexperienced users. Certain inexperienced users may not be allowed to make certain settings. By providing such information to the LLM, the LLM can ensure that user assistance that would require the user to take certain actions that are outside the set of permitted actions are not provided. User irritation can be avoided.

Above, scenarios have been disclosed in which the context data is related to, e.g., the microscope, the GUI, software executed based on image data acquired by the microscope, and/or the user. Alternatively or additionally, the context data may be related to the sample under investigation. For instance, the context data may be indicative of a sample type, a sample processing history, a sample size, and/or a structure size of the structures of the sample. A textual description of a microscopic image depicting the sample may be provided. Oftentimes, different types of samples require different strategies for imaging. For instance, there are certain biological structures that are barely visible when using aptitude imaging. For such structures, e.g., cells, it may be beneficial to use phase contrast imaging. Furthermore, when choosing the field of view and/or the magnification and appropriately, certain structures may not be depicted because they are below the resolution or because they are too large to be perceived in a restricted field of view. All such information may be considered by the LLM and providing the user assistance if provided with information on the sample.

The user assistance information may generally refer to any information provided to a user of a microscope to assist them in operating the microscope and/or interpreting images acquired using the microscope. Such information may include, but is not limited to, guidance on how to adjust settings of the microscope, how to select imaging modalities, how to use post-processing software, or how to interpret results obtained from image analysis. In this context, user assistance information may be provided in various forms, such as text-based instructions, visual aids like diagrams or images, or even interactive tools that guide the user through a specific process. The type and format of the user assistance information may depend on the specific needs of the user, the complexity of the microscope, and the level of expertise required to operate the microscope. For example, in some cases, the user assistance information may be provided as a series of step-by-step instructions that guide the user through a specific imaging protocol. In other cases, the user assistance information may be more general, providing an overview of different imaging techniques or modalities available on the microscope, and allowing the user to select the most suitable approach for their specific application. In addition, user assistance information may also include troubleshooting guides, which provide guidance on how to resolve common issues or errors that may arise during operation of the microscope. Such guides may be particularly useful for users who are new to microscopy or have limited experience with a particular type of microscope.

There are various options available for implementing the user assistance information. For instance, a tutorial guided workflow for user interaction may be provided. The tutorial/guided workflow may pertain to the user interaction with the GUI. For instance, a step-by-step set of instructions can be provided for the user regarding which interface elements to activate or manipulate and/or which settings are required to achieve a certain goal. The goal may be defined by the user query or generally the logic of determining that user assistance is required. as mentioned above, the user assistance information or, even more generally, the ways of providing the user assistance information may depend on the skill level of the user

There are various options available on how to provide the user assistance information to the user. For example, the user assistance information may be provided to the user via the GUI. For example, the user assistance information may include a graphical highlight of at least one interface element of the GUI. For instance, a graphical highlight may be provided for those interface elements that are to be clicked, activated, or otherwise manipulated by the user. In an alternative, a tooltip pop-up associated with a certain interface element may be provided. Such tooltip pop-up can include a textual description. Respective text may be generated by the LLM. The textual description may include, e.g., a functionality of the interface elements.

Such techniques may be facilitated by the LLM providing certain texts that can be parsed and post-processed by a program associated with the GUI. The format of such texts can be specified in the prompt. For instance, the LLM may provide a table that indicates the particular sequence of interface elements that need to be highlighted. Such information may then be input to a program associated with the GUI in order to provide such highlighting or other emphasis of certain interface elements. By providing information directly within the GUI, a particularly intuitive and easy-to-follow user assistance can be provided.

The user assistance information may also be provided external to the GUI. For instance, the user assistance information may be provided at a separate computing device, e.g., a separate handheld user device such as a smart phone. This may enable backwards compatibility with different types of GUIs. There is not required to be a particular software interface for interfacing between the LLM output and the GUI. This enables separation of the computing device controlling the microscope and executing the GUI from external data sources.

As a general rule, the provisioning of the user assistance may be queried by the user. In other words, the user may provide a respective manual query for the user assistance. Then, upon a respective user-triggered request, the inference of the LLM is triggered. Alternatively or additionally to such manual and explicit triggers of the generation of the user assistance, semiautomatic or fully automatic triggers are also conceivable. Implicit trigger events may be detected. Inference of the LLM may more generally be triggered by at least one trigger event. For example, user interaction with the GUI may be monitored in order to determine whether the at least one trigger event is being met. For instance, a background process may monitor user interaction with one or more interface elements of the GUI. Then, that background process may automatically determine whether the user is a need for user assistance; in the affirmative, the inference of the LLM may be triggered. To give a concrete example, an abnormal user interaction pattern may be detected and the at least one trigger event may include the abnormal user interaction pattern. Above, techniques have been already explained regarding possibilities for detecting the abnormal user interaction pattern; while these techniques have been discussed above in connection with the context data, these techniques can be readily applied also for judging whether a trigger for inference of the LLM is being met. Such techniques are based on the recognition that certain abnormal user situations may be prone to user error, so that the user may be in particular need of user assistance when acting outside of standard patterns. At the same time, by identifying abnormal user situations, it is possible to avoid having to provide the user with repeated user assistance too often, which would risk annoyance.

Said monitoring of the user interaction may include detecting a change of a setting of a interface element of the GUI. For instance, upon detecting that the user changes a certain interface element, user assistance tailored to that particular change of the setting can be queried at the LLM. The user interaction may include change of visibility of the interface element of the GUI. For instance, a user may activate visibility of a given interface element; upon this occasion, user assistance with respect to that particular interface element may be queried at the LLM.

Said monitoring of the user interaction may include monitoring a change of the software version of the GUI. For instance, upon detecting a change of the software version of the GUI, user assistance may be queried. For instance, user assistance may be queried that is tailored to differences between the updated software version of the GUI and a previously installed software version of the GUI.

The method may further include determining a prompt for the LLM based on a user query. For example, the user may input a query using, e.g., text input or speech-to-text input. The prompt may encapsulate that user query, e.g., along with the context data. It would also be possible that the user query is preprocessed and then the preprocessed user query may be included in the prompt. The prompt may generally include such user query along with the context data. It is not necessary that the prompt is constructed based on a user query in all scenarios. For example, above, techniques have been disclosed in which – based on monitoring of the user interaction with the GUI – a trigger criterion for obtaining the user assistance information is detected. In such scenarios, it may suffice to provide a descriptor indicative of the user interaction along with the context data in the prompt to the LLM to provide the user assistance information. In such a scenario and further scenarios, explicit formulation of a user query is not required.

According to examples, said providing of the GUI is executed in an encapsulated operating system. For example, the computing device including a processor and a memory storing program code for executing the GUI may be located in a local area network that is disconnected from the Internet. In such a scenario, the LLM may be locally executed at that computing device. In another scenario, the LLM may be deployed in the cloud, i.e., accessible via the Internet. Then, triggering of the inference of the LLM may be triggered by one or more processes executed at another computing device than the computing devices that provides the GUI. That other computing device that triggers the inference of the cloud-deployed LLM may then be connected to the Internet so that the respective command for inference of the LLM is communicated via the Internet. by encapsulating the programs for microscope control and provisioning of the GUI from programs required for triggering inference of the LLM, security of the encapsulated operating system controlling the microscope and providing the GUI is increased. For instance, data leakage can be effectively prevented.

The method may further include executing a data transfer of at least a part of the context data between the operating system – i.e., the operating system providing the GUI – and the further operating system – i.e., the operating system triggering the inference of the LLM. Such data transfer can be a secure data transfer. Secure data transfer means that by appropriate restrictions and constraints imposed on the data transfer, it can be ensured that only the intended information, i.e., the at least part of the context data, is transferred; while other information, in particular microscope images including information on the sample etc., cannot be communicated using the data transfer. For example, the data transfer may be via one or more optical codes, e.g., QR codes. The data transfer may be via a near-field wireless transmission and/or an ad hoc wireless transmission. such types of data transfer may have an inherently limited data transfer rate so that payload data, in particular, microscopic images, cannot be accommodated within a limited time duration. The data transfer may require manual user interaction, e.g., for clearance of certain information to be shared. Thereby, the user maintains control of the information that is shared beyond the encapsulated operating system.

The method may further include detecting that the microscope is not connected to the Internet and then storing the context data locally on the microscope responsive to detecting that the microscope is not connected to the Internet. The method may further include transferring the stored context data to a secondary device, e.g., using an optical code scanning technique, a Universal Serial Bus (USB) connection, a Near Field Communication (NFC) transmission, a Bluetooth(c) transmission or a WLAN connection. The secondary device then triggers the inference of the LLM. The transferring of the stored context data may be performed using a dynamic QR code or a video QR code.

Triggering inference of the LLM may include providing a respective prompt to a computing device executing the LLM. The prompt may include at least parts of the context data, e.g., in a compressed format. For instance, a latent representation of the context data may be determined based on a pre-trained encoder. The latent representation may be in the machine-learned latent space interpretable by the LLM.

Alternatively, the context data may request the LLM to retrieve information from one or coded and structured knowledge elements. Such coded and structured knowledge elements may include, e.g., a manual of the microscope, a manual of the GUI, a performance specification database of one or more optical elements of the microscope, a log file of the microscope, a technical whitepaper, and/or an error database of the microscope. Retrieval Augmented Generation (RAG) may be employed. RAG refers to a method where the LLM uses external information or data alongside its own training to generate responses. In the context of the present disclosure, RAG may involve retrieving relevant information from a document database based on the context data. This approach enhances the accuracy and relevance of the user assistance provided, as it leverages both the LLM's general knowledge and specific contextual information.

A performance specification database of one or more optical elements may be a collection of data that describes the characteristics and capabilities of the optical elements used in the microscope. Such databases are typically compiled by the manufacturer of the optical elements and provide detailed information on various parameters such as numerical aperture, magnification, resolution, and spectral transmission range, among others. This information can be useful for understanding how different optical elements contribute to the overall imaging performance of the microscope.

Technical whitepapers may refer to scientific or technical documents that provide an in-depth analysis or explanation of a particular topic related to microscopy, such as new techniques, methods, or technologies. These papers are typically written by experts in the field and provide detailed information on theoretical aspects, experimental results, and practical applications of various microscopic imaging modalities. In the context of providing user assistance, technical whitepapers can serve as a valuable resource for understanding complex concepts and providing accurate guidance to users.

A manual of the microscope or the GUI may be a document that provides comprehensive instructions and explanations on how to use the microscope or interact with the GUI. Such manuals typically cover topics such as setup and calibration procedures, operational modes, troubleshooting guidelines, and maintenance recommendations. These documents can provide valuable context for understanding user behavior and intentions when interacting with the microscope.

According to examples, the method may further include providing a user feedback mechanism to add, to a user feedback database, input from the user. The input from the user may pertain to the usefulness and/or the relevance of the user assistance information. Thereby, the user is able to rate or benchmark the quality of the user assistance information. Then, further context data can be generated based on such user feedback database. For instance, certain user assistance information that has been previously labeled by a user to be particularly useful, can be reused in a further instance of another user requiring user assistance information. On the other hand, negative samples in which user assistance information was not found to be particularly helpful for a user may serve as negative examples so that the LLM can provide alternative solutions.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a system including a microscope and a computing device according to various examples.

FIG. 2 schematically illustrates a system including a microscope and a computing device executing an encapsulated operating system as well as a further computing device connected to the Internet according to various examples.

FIG. 3 is a flowchart of a method according to various examples.

FIG. 4 schematically illustrates a GUI according to various examples.

### DETAILED DESCRIPTION OF THE INVENTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), a tensor processing unit (TPU), integrated circuits such as application-specific integrated circuits or field-programmable gate array (FPGA) circuitrs, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

According to various examples, an LLM is used to provide user assistance to the user when using a microscope to investigate a sample. The LLM, for this purpose, is prompted based on context data that is generated based on a current setting of the microscope.

The techniques disclosed herein enable tailored user assistance, aware of the particular state of the microscope and/or the GUI through which the user controls the microscope. Furthermore, the techniques disclosed herein enable user assistance even in scenarios where the microscope is in a protected environment encapsulated not to be connected to the Internet.

The disclosed techniques may incorporate configuration data, a current state of the microscope, and/or data from the microscope control software, as additional context for the LLM. This comprehensive contextual information may be provided alongside any user queries to refine searches within a document database. By potentially narrowing down the relevant documents and enhancing the quality of responses, this approach ensures that user assistance is both precise and efficient. Further, the disclosed techniques enable offline-to-online data transfer: In scenarios where the microscope lacks internet connectivity, but cloud-based solutions are desired, the disclosure may propose storing configuration data, current state information of the microscope, and control software details locally. This stored data can then be transferred to a secondary device with internet access via various methods. For instance, QR Code Transmission may be employed where such data may be encrypted into a QR code. The user scans this QR code using a smartphone, accesses the cloud solution, uploads the data, and interacts with a chatbot or similar AI assistant. For larger datasets, dynamic QR codes (e.g., video or color QR codes) can be employed to accommodate greater data volumes. Alternative Transfer Methods include USB connections, NFC, Bluetooth, or Wi-Fi, offering flexible options depending on the user's preferences and available hardware. By integrating these features, the disclosure ensures that users receive timely and relevant assistance tailored to their specific microscopy tasks, regardless of the system's connectivity status.

Various techniques are based on the finding that LLM-based copilot-style user assistance can provide step-by-step instructions that include descriptions of the GUI. To provide such instructions, an LLM that provides the instructions is prompted with an understanding of the GUI. In reference implementations, this is provided by user manuals. Such manuals can be incomplete and inaccurate. Hence, according to the disclosed techniques, the context data may include machine-readable descriptions of the user interface. This enables providing accurate information to the LLM for a GUI that shows variations across multiple software versions and further enables the LLM to adapt the user assistance information dynamically to user settings. According to examples of the disclosure, the generation of the context data may occur locally at a computing device executing the GUI for control of the microscope, ensuring the context data remains accurate and current.

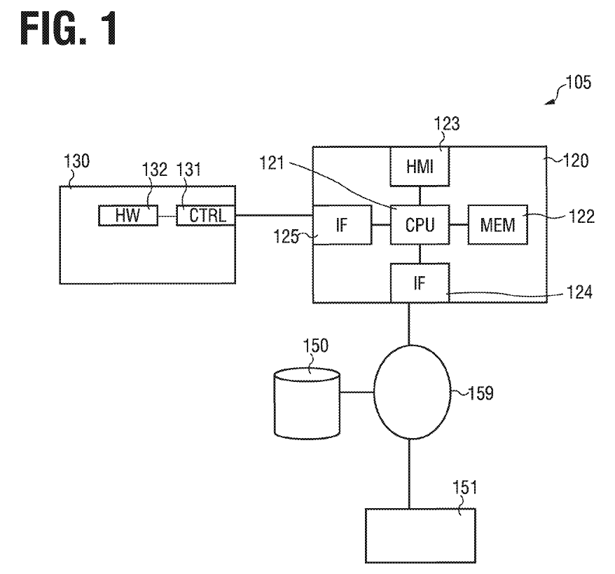

FIG. 1 schematically illustrates a system 105 according to various examples. The system 105 includes a microscope 130. The microscope 130 may be a light microscope, e.g., configurable for brightfield imaging, dark-field imaging, phase-contrast imaging, fluorescence imaging, etc. The microscope 130 includes a control circuitry 131 that controls imaging hardware 132. The control circuitry may execute a system software of the microscope. Such system software may generate log files for the microscope 130. The microscope 130 may include sensors for state monitoring, e.g., health monitoring. The imaging hardware 132 may include, e.g., an illumination module, a sample holder module, an objective lens, a camera, one or more filters, etc. Some of these components may be motorized, e.g., the sample holder module to move and position the sample holder and the sample attached data relatively to the optical path defined by the objective lens. The illumination module may be controlled to activate different illumination patterns. The camera may be controlled to implement different image acquisition settings. These are just some examples of possible settings of components of the microscope 130 that can be adjusted by the control circuitry 131. For this, the control circuitry 131 is configured to receive respective control data from a control interface 125 of a computing device 120. The computing device 120 includes a processor 121 and a memory 122. The computing device 120 further includes a human machine interface (HMI) 123 and a communication interface 124. The processor 121 can load program code that is stored in the memory 122 and execute the program code. The processor 121, upon loading and executing the program code, can perform techniques as disclosed herein, e.g., providing a GUI to a user via the HMI 123, controlling an appearance of the GUI, providing control data to the control circuitry 131 of the microscope 130 based on one or more settings of one or more interface elements of the GUI, postprocessing raw image data obtained from the microscope 130, e.g., by filtering, combining, denoising, regularization, and further operations, and communicating with a database 150 and/or a server 151, e.g., to trigger inference of an LLM. The processor 121 can communicate with the Internet 159 via the communication interface 124. For instance, certain knowledge elements may be retrieved from the database 150. These knowledge elements may be encapsulated in a prompt to an LLM that is inferred at the server 151. RAG may be used.

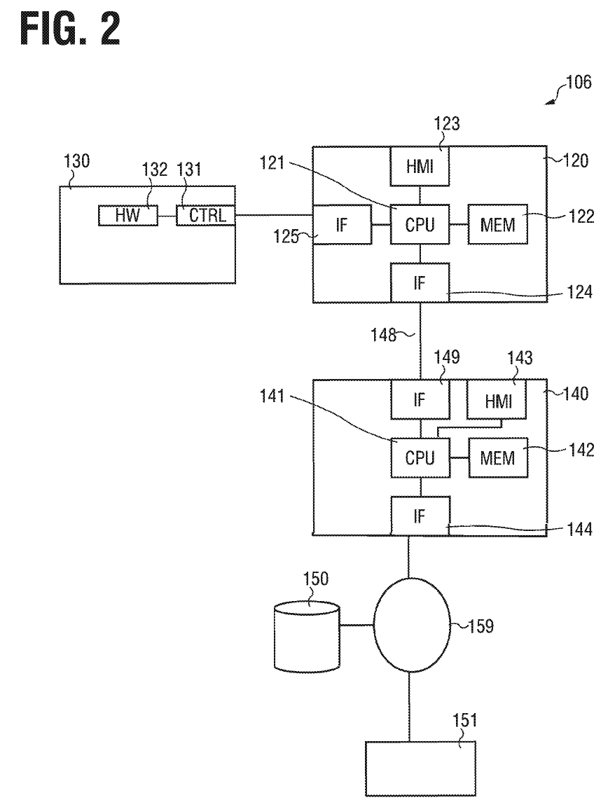

While the computing device 120 of the system 105 illustrated in FIG. 1 is connected directly to the Internet 159, in other scenarios the processor 121 of the computing device 120 may execute an encapsulated operating system. Such a scenario is illustrated in FIG. 2.

FIG. 2 generally corresponds to FIG. 1. More specifically, the system 106 illustrated in FIG. 2 generally corresponds to the system 105 illustrated in FIG. 1. In the scenario of FIG. 2, however, the computing device 120 is not directly connected to the Internet 159. Rather, a secure data transfer 148 can be executed between the computing device 120 and another computing device 140. This secured data transfer may be implemented, e.g., by an optical code, NFC, WLAN or Bluetooth. The computing device 140, for this purpose, includes a respective communication interface 149 that can communicate with the communication interface 124 of the computing device 120 using the secure data transfer 148. The computing device 140 also includes a processor 141, a memory 142, an HMI 143, and a communication interface 144. The communication interface 144 is connected to the Internet 159 and may retrieve knowledge elements from the knowledge database 150 and/or trigger inference of an LLM at the server 151.

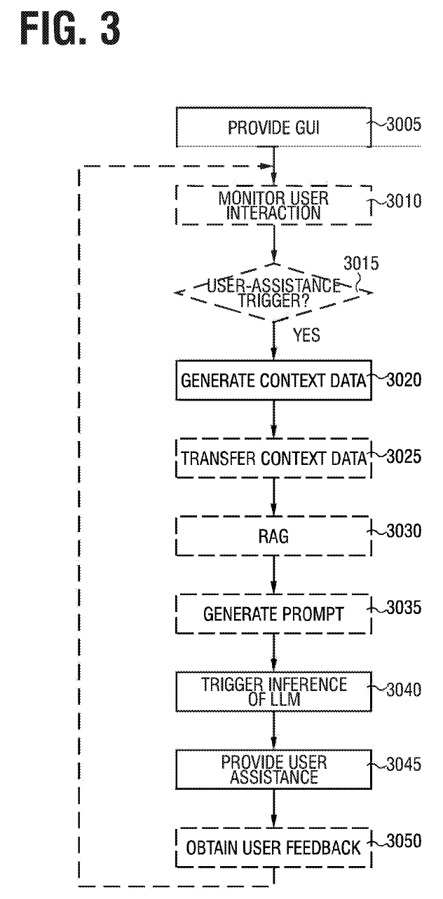

FIG. 3 is a flowchart of a method according to various examples. Optional boxes are shown with dashed lines. The method of FIG. 3 may be executed by a computing device. More specifically, the method of FIG. 3 may be executed by a processor, upon loading and executing program code from a memory. For example, the method of FIG. 3 may be executed at multiple distributed computing devices. For instance, at least parts of the method of FIG. 3 may be executed by the processor 121 of the computing device 120 (cf. FIGS. 1 and 2); alternatively or additionally, at least parts of the method of FIG. 3 may be executed by the processor 141 of the computing device 140 (cf. FIG. 2). The method of FIG. 3 generally pertains to providing user assistance to a user when using a microscope (cf. FIG. 1, FIG. 2: microscope 130). The user assistance is implemented by user assistance information that is generated, at least in parts, based on an output of an LLM. The LLM may be cloud-deployed, e.g., executed by one or more servers such as the server 151 connected via the Internet 159 to one or more computing devices executing the method of FIG. 3. In some examples, the LLM may also be locally deployed, e.g., one or more computing devices executing other steps of FIG. 3 may also execute the inference of the LLM.

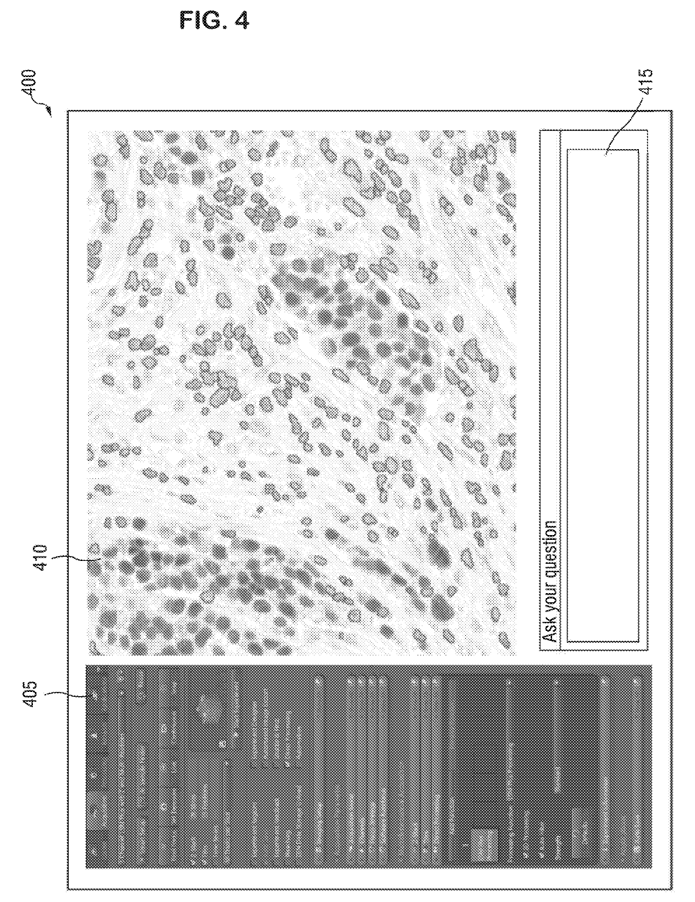

At box 3005, a GUI is provided. The GUI may be provided via an HMI, e.g., the HMI 123 of the computing device 120 previously discussed in connection with FIG. 1 and FIG. 2. The GUI includes multiple interface elements. Manipulation of these interface elements enables setting properties of the image acquisition process at the microscope 130, e.g., by controlling one or more of the hardware components of the imaging hardware132. Manipulation of these interface elements may alternatively or additionally enable setting properties of digital image postprocessing that is executed by the control circuitry 1311 of the microscope 130 and/or the processor 121 of the computing device 120. FIG. 4 illustrates an example implementation of a GUI 400. The GUI 400 includes a toolbar 405 including multiple interface elements via which properties of the image acquisition and/or the image postprocessing can be adjusted. Further, the GUI 400 includes an area 410 in which a microscopic image is displayed. In the scenario of FIG. 4, the microscopic image is overlaid with certain localization information, here, a segmentation mask for cells, obtained from postprocessing. The GUI 400 also includes a multiline text form 415 via which the user can input a query for user assistance. The GUI 400 illustrated in FIG. 4 is only one of many possible examples and various modifications are conceivable. Firstly, the GUI 400 may not incorporate the multiline text form 415; in some examples, user assistance may not be provided based on an explicit user query but rather based on monitoring of user interaction with the GUI. Even if a text query is obtained from the user, this text query may be obtained through a separate GUI, e.g., a GUI provided by the computing device 140 via the HMI 143. Furthermore, the type of depicted microscopic image as well as the type and number of interface elements may vary from implementation to implementation. In some scenarios, the GUI 400 itself may be re-configurable so that the number and function of interface elements that are visible in the GUI 400 can be reconfigured by the user.

Referring again to FIG. 3: at box 3010, user interaction with the GUI may be monitored to determine whether a trigger event is met. For instance, abnormal user interaction may be detected in box 3010. A change of a setting of an interface element of the GUI may be detected. A change in visibility of an interface element of the GUI may be detected. A change of a software version of the GUI may be detected.

At box 3015, it is then judged whether a user-assistance trigger is present. For instance, determining whether a trigger event is present may be based on the monitoring of the user interaction at box 3010. Alternatively or additionally, it may be judged whether the user has provided a user query for user assistance to the system. For instance, an explicit, textual user query as previously discussed with the multiline text form 415 in FIG. 4 could be obtained. Here, the user-assistance trigger obtained from the user may not only be obtained at the particular operating system and computing device that executes the GUI at box 3005; it would be possible that the user query as user assistance at a secondary device (cf. FIG. 2: computing device 140).

If, at box 3015, a trigger event is detected, the method commences at box 3020.

At box 3020, context data is generated. The context data is generally associated with the microscope. The context data may be indicative of a current hardware setting of the microscope. The context data may be indicative of a current image acquisition setting of the microscope. The context data may be indicative of a log file of the microscope. The context data may be indicative of an error message output by a system software of the microscope. The context data may be indicative of a sensor reading of a sensor of the microscope.

The context data may be indicative of a current software configuration of an image processing module of the microscope. Such image processing module may be executed by a system software of the microscope and/or by a computing device attached to the microscope, such as the computing device 120 previously discussed in connection with FIG. 1 as well as in connection with FIG. 2. The context data may be indicative of a current setting of the GUI provided at box 3005. For instance, this may pertain to an indication which interface elements are presently visible or presently hidden in the GUI. Alternatively or additionally, it may be possible that the context data is indicative of position information for the interface elements, e.g., indicative of their arrangement in the GUI. All such information may be helpful in order to provide tailored user assistance, adapted to the particular set up of the microscope and its software as well as to the particular set up of the GUI.

The context data may be indicative of a user interaction with the GUI. For instance, it may be indicated which particular interface elements have been actuated by the user. A history of user interactions of a particular user interacting with the GUI may be indicated by the context data.

The context data may be indicative of user-related information such as a user identifier, a user skill level, and abnormal user interaction pattern of the user interacting with the GUI, and/or a user permission level.

The context data may be indicative of a sample type, a sample processing history, a sample size and/or a structure size of structures of the sample that is currently under investigation at the microscope.

As will be appreciated from the above, the context data may be closely related to the current state of the microscope, the GUI, the sample under investigation, and/or the user of the microscope. Accordingly, in some scenarios, the context data may be generated at a computing device that is attached to the microscope. Sometimes, this computing device may execute an operating system in a protected environment. Then, in such a scenario, the context data may be transferred, at box 3025, to another computing device.

At box 3025, the data transfer of at least a part of the context data may be executed between the operating system executing the GUI and the further operating system. Such data transfer may be protected in the sense that it may be limited to such parts of the context data. For instance, it may be encrypted. For instance, the data rate throughput may be limited. For instance, it may be subject to one or more information constraints limiting the type of information that can be conveyed in the data transfer. For instance, it may be encrypted. Manual user interaction, e.g., manual user clearance may be required. For instance, it may be limited in its range, e.g., a near-range communication may be employed. For instance, referring to FIG. 2, the data transfer 148 between the computing device 120 and the computing device 140 may be executed at box 3025. The data transfer may be executed using one or more optical codes. Alternatives include near-field wireless transmission and/or ad-hoc wireless transmission.

At box 3030, RAG may be executed. For example, box 3030 may include triggering retrieval of information from one or more coded and structured knowledge elements. This may include accessing a respective knowledge repository or triggering the LLM to retrieve this information. example knowledge elements include a manual of the microscope, a manual of the GUI, a performance specification database of one or more optical elements of the microscope, technical white papers, logfiles of the microscope, or an error database of the microscope. If such information is directly retrieved, then such information may be incorporated into the prompt that is subsequently generated at box 3035.

It is optionally possible at box 3035 to generate a prompt for the LLM. For instance, the prompt can be determined based on a user query and/or based on alternative information that is indicative of the circumstances describing the required user assistance, e.g., as obtained from the monitoring at box 3010.

Box 3035 is optional because in some scenarios the user query if available in text form may be directly provided to the LLM as a prompt. By specifically generating the prompt, it is possible to take into account certain knowledge regarding the operation of the LLM. For instance, the prompt may be generated based on a prompt database in which certain acceptable prompts are stored. Then, these predefined problems may be modified to some extent based on the current situation.

At box 3040, the inference of the LLM is triggered. The LLM may be cloud-deployed, i.e., executed at a server. In such a scenario, triggering of the inference of the LLM may include providing, via the Internet, the prompt to the server hosting the LLM and querying the server to infer the LLM based on that prompt. In other examples, the LLM may be locally deployed. In such a scenario, box 3040 can include the actual inference of the LLM at the local computing device hardware.

The inference of the LLM causes user assistance information to be obtained. The user assistance information is then provided to a user at box 3045.

As a general rule, the user assistance information may include textual information as generated by the LLM. At least parts of such textual information may be converted to sound output using a text-to-speech model. Then, playback of a corresponding audio waveform can be triggered.

In further scenarios, the user assistance information may be alternatively or additionally provided via the GUI provided at box 3005, e.g., as a graphical highlight of an interface element of the GUI or as a tooltip pop-up that is associated with an interface element. Such tooltip pop-up may include textual description of a functionality of that interface element. however, it is not required that the user assistance information is provided via the GUI. For instance, the user assistance information may be provided via separate HMI, e.g., providing another GUI at another device so that interaction with the encapsulated operating system is not required at box 3045. For instance, the user assistance information may be displayed to the user in a GUI executed at a smart phone of the user.

The user assistance information may pertain to, e.g., a tutorial or guided workflow for user interaction with the GUI. The user assistance information and/or said providing of the user assistance information may depend on a skill level of the user.

At box 3050, it is optionally possible to obtain user feedback. The user feedback may be indicative of usefulness and/or relevance of the user assistance information previously provided at box 3045. Such user feedback may be gathered via a user feedback mechanism. The user feedback may be explicit, e.g., the user may be explicitly asked to provide feedback regarding the usefulness and/or relevance of the user assistance information. Alternatively or additionally, the user feedback may be implicit, e.g., based on a usage pattern of the user upon obtaining the user feedback. For instance, if the user follows the instructions provided by the user assistance information, it may be judged that the user assistance information was helpful; conversely, if the user decides to deviate from the user instructions provided via the user assistance information, it may be judged that the user assistance information was not helpful. The user feedback mechanism may add this user feedback to a user feedback database so that subsequent context data may be generated based on the user feedback database.

As shown by the feedback arrow in FIG. 3, upon providing the user assistance information at box 3045 and upon optionally obtaining user feedback at box 3050, a further iteration of box 3010 can be executed. Thereby, continued machine-user interaction can be provided. The user can be continuously guided through multiple control steps of controlling the microscope and the image acquisition by means of the GUI.

Summarizing, techniques have been disclosed that generally relate to providing user assistance when using a microscope to acquire images of a sample. The techniques involve generating context data for the current setting of the microscope and organizing it into a standardized machine-comprehensible format. This context data is then used by an LLM to provide accurate user guidance to the user, such as which interface elements to use or set in a certain manner to achieve a desired result. The context data may include information about the microscope's current hardware setting, image acquisition setting, software configuration, and user interaction with the GUI. This data can also include log files, error messages, sensor readings, and other information that pertains to the overall operation of the microscope. The LLM uses this context data to provide tailored user assistance, taking into account the specific situation faced by the user when interacting with the GUI. The user assistance may be provided in various forms, such as text-based instructions, visual aids, or interactive tools that guide the user through a specific process.

In some examples, the user assistance information may be queried by the user manually, while in other cases, it may be triggered automatically based on monitoring of the user interaction with the GUI. The user assistance information may also be provided external to the GUI, such as on a separate handheld device.

The techniques may include executing a data transfer of at least part of the context data between the operating system providing the GUI and another operating system triggering the inference of the LLM. This data transfer may be secure and limited to only the intended information, preventing other information from being communicated.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For illustration, while above scenarios have been disclosed in which a single LLM is used, in some scenarios, the task of providing user assistance information may be broken down in multiple subtests and multiple subtasks may be allocated to different LLMs. Also, a multi-agent system is conceivable in which multiple LLM-defined agents cooperate in solving a certain task for providing user assistance information. A multi-agent system is an architectural framework in which multiple agents interact and collaborate to accomplish a shared goal. Such systems are particularly useful when the task at hand can be decomposed into subtasks that can be allocated to different agents, each possessing distinct capabilities or expertise. For instance, in the context of user assistance, one agent may specialize in natural language processing, while another may focus on retrieving technical documentation or operating system logs. Each agent in a multi-agent system may operate under varying degrees of autonomy, ranging from tightly coupled collaboration to loosely coordinated interaction.

For still further illustration, while various examples have been disclosed in connection with light microscopy, similar techniques may be applied to, e.g., scanning particle microscopes, e.g., scanning electron microscopes.

For still further illustration, various examples have been disclosed in the context of a GUI for control of a microscope. However, similar techniques may also be applied to other machinery, e.g., volumetric imaging tools such as Computed Tomography scanners, Magnetic Resonance Imaging scanners, lithography tools such as exposure equipment, micromanipulators, to give just a few examples.

What is claimed is:

1. A computer-implemented method for providing user assistance when using a microscope to investigate a sample, the method comprising
providing a graphical user interface to a user, the graphical user interface for depicting a microscopic image of the sample acquired using the microscope and for enabling setting of a configuration of an imaging process associated with the microscopic image,
based on a current setting of the microscope, generating context data for the microscope,
based on the context data, triggering inference of a trained large language model to generate user assistance information, and
providing the user assistance information to the user.

2. The computer-implemented method of claim 1,
wherein the context data is indicative of a current hardware setting of the microscope, a current image acquisition setting of the microscope, or a combination thereof.

3. The computer-implemented method of claim 1,
wherein the context data is indicative of a log file of the microscope, an error message output by a system software of the microscope, a sensor reading of a sensor of the microscope, or any combination thereof.

4. The computer-implemented method of claim 1,
wherein the context data is indicative of a current software configuration of one or more image processing software modules of the microscope.

5. The computer-implemented method of claim 1,
wherein the context data is indicative of a current setting of the graphical user interface.

6. The computer-implemented method of claim 5, wherein the current setting of the graphical user interface is defined by visible interface elements, hidden interface elements, positions of interface elements, or any combination thereof.

7. The computer-implemented method of claim 1,
wherein the context data is indicative of a user interaction with the graphical user interface.

8. The computer-implemented method of claim 1,
wherein the context data is indicative of user-related information, the user-related information comprising a unique user identifier, a user skill level, an abnormal user interaction pattern with the graphical user interface, a user permission level, or any combination thereof

9. The computer-implemented method of claim 1,
wherein the user assistance information is provided to the user via the graphical user interface.

10. The computer-implemented method of claim 9,
wherein the user assistance information comprises a graphical highlight of an interface element of the graphical user interface, a tooltip popup associated with an interface element comprising a textual description of a functionality of the interface element, or a combination thereof.

11. The computer-implemented method of claim 1,
wherein the inference of the trained large language model is triggered by at least one trigger event, and
wherein the method further comprises:
monitoring a user interaction with the graphical user interface to determine whether the at least one trigger event is met.

12. The computer-implemented method of claim 11,
wherein said monitoring of the user interaction comprises:
detecting an abnormal user interaction pattern, and
wherein the at least one trigger event comprises the abnormal user interaction pattern.

13. The computer-implemented method of claim 11,
wherein said monitoring of the user interaction comprises detecting a change of a setting of a interface element of the graphical user interface, a change in visibility of a interface element of the graphical user interface, a change of a software version of the graphical user interface, or any combination thereof.

14. The computer-implemented method of claim 1, further comprising:
determining a prompt for the trained large language model based on a user query.

15. The computer-implemented method of claim 1,
wherein said providing of the graphical user interface is executed in an encapsulated operating system,
wherein the trained large language model is cloud-deployed,
wherein said triggering of the inference of the trained large language model is executed in a further operating system that is connected to the Internet.

16. The computer-implemented method of claim 15, further comprising:
executing a data transfer of at least a part of the context data between the operating system and the further operating system via one or more optical codes.

17. The computer-implemented method of claim 1, further comprising:
triggering retrieval of information from one or more coded and structured knowledge elements.

18. The computer-implemented method of claim 1, further comprising:
providing a user feedback mechanism to add, to a user feedback database, input from the user regarding the usefulness and/or relevance of the user assistance information,
wherein the context data is generated based on the user feedback database.

19. The computer-implemented method of claim 1, wherein the user assistance information comprises a tutorial or guided workflow for user interaction with the graphical user interface.

20. One or more computing devices, the one or more computing devices comprising at least one processor and at least one memory, the at least one processor being configured to load program code from the at least one memory and to execute the program code, execution of the program code causing the at least one processor to perform the method according to claim 1.
